(19) United States
(12) Patent Application Publication
(10) Pub. No.: US 2010/0023968 A1
(43) Pub. Date: Jan. 28, 2010

(54) Community-Based Enhanced Television

(75) Inventor: Jeffrey R. Wannamaker, London (CA)

Correspondence Address: Saul Ewing, LLP;TVWORKS, LLC, 1500 MARKET STREET, 38th Floor, PHILADELPHIA, PA, 19102, US

(73) Assignee: TVWorks, LLC, c/o Comcast Cable, Philadelphia, PA (US)

(21) Appl. No.: 12/177,904

(22) Filed: Jul. 23, 2008

(51) Int. Cl. H04N 5/445; H04N 7/173

(52) U.S. Cl. 725/37; 725/116

(57) ABSTRACT

The invention pertains to a method and apparatus for generating an enhanced television event at a set top box in a television network comprising, playing a television program via the set top box, selecting a point in the television program using the set top box, generating content comprising the enhanced television event, storing the content in a memory storage device in the set top box, and creating an enhanced television event dataset by associating the content with the television program and the point in the television program.

### FIELD OF THE INVENTION

The invention pertains to the creation and delivery of enhanced television content.

### BACKGROUND OF THE INVENTION

Interactive television and enhanced television has been an evolving technology for some time now and takes various forms. However, in essence, enhanced television and interactive provides an interface mechanism that permits a viewer to selectively view audio-visual content separate and in addition to the audio-visual content of the particular television program being viewed. Enhanced television and interactive television are quite similar and, in fact, the terminology is sometimes used interchangeably in the field. However, the term enhanced television generally refers to situations in which the supplemental content relates to a specific base content and is intended to be used in connection to that base content. The term interactive television, on the other hand, generally is used to describe the provisioning of supplemental content wherein there is not necessarily a relation to any particular content. Enhanced television usually involves a two-way communication link between the viewer's node and the headend, such as may be provided by hybrid fiber-coaxial (HFC) cable television system operators, satellite television system operators (via a telephone link) and fiber-optic cable television system operators. For example, in a practical embodiment, the television system operator may insert a small icon in a corner of the television screen whenever supplemental content (i.e., enhanced television) is available for viewing. The viewer's television remote control unit and/or set top box (STB) may be provided with a button for activating the enhanced television or interactive television feature (hereinafter collectively referred to as enhanced television). If the user depresses the enhanced television button on the remote control unit when the icon is displayed, the set top box causes the supplemental content to be displayed or, alternately, causes a menu of options pertaining to the viewing of supplemental content to be displayed. Assuming the set top box incorporates a Digital Video Recorder or the like, the original program being viewed may be paused responsive to the button. However, enhanced television services may be provided without the use of a two-way communication link. For instance, enhanced content can be inserted in the broadcast programming and the subscriber's set top box will see this data if it is tuned to the channel at the time and can handle such content per the user's instructions without the need to communicate upstream with the headend. An existing format for such data is called EBIF (http://en.wikipedia.org/wiki/Enhanced_TV_Binary_Interchange_Format). A set top box can contain ETV agent software that understands EBIF and interprets its contents. The data can contain text, images, formatting information and even logic to tell the agent how to respond to user actions. This can be done without a two-way link, and might be sufficient for many types of enhanced television applications.

In any event, in the menu-based embodiment, the viewer can scroll through the menu using appropriate buttons located on the remote control unit to select a menu option, such as choosing to view a particular piece of supplemental content. If the user chooses to view an item of supplemental content, the set top box makes a request that content be transmitted to it from the headend and, when received, causes the content to be displayed on the television. When the supplemental content is done, the original program may automatically be restarted from where it was paused or the STB may wait for another user input (such as depressing the PLAY button) before restarting the original program.

The supplemental content can be virtually anything that may be of interest to someone watching the particular segment of the original program during which the enhanced television icon appeared. Merely by way of illustrative example, a program featuring a particular actor in a particular scene may offer the viewer the option of one or more of (1) reading a biography of the actor, (2) seeing a filmography of the act, (3) viewing a video clip about the actor, and/or (4) viewing a list of upcoming television programs featuring that actor.

While the technology of enhanced television has continued to advance rapidly, the amount of supplemental content available for use in enhanced television is relatively meager. Such content generally is created by the television system operator, the producer of the program, or one of a few specialized companies that create supplemental content for enhanced television programming. Consequently, such supplemental content generally is created only for the most popular television programs. Also, very little, if any, supplemental content is available for television programs produced before the advent of enhanced television.

### SUMMARY OF THE INVENTION

The invention pertains to a method and apparatus for generating an enhanced television event at a set top box in a television network comprising, playing a television program via the set top box, selecting a point in the television program using the set top box, generating content comprising the enhanced television event, storing the content in a memory storage device in the set top box, and creating an enhanced television event dataset by associating the content with the television program and the point in the television program.

### BRIEF DESCRIPTION OF THE DRAWINGS

FIG. 1 is a block diagram of the components of a cable television network system that supports features in accordance with the present invention.

FIGS. 2, 3, and 4 are exemplary interface screens that can be used in connection with the present invention.

FIG. 5 is a flow diagram illustrating one exemplary process for generating and uploading supplemental content in accordance with the principles of the present invention.

FIG. 6 is a flow diagram illustrating one exemplary process for downloading and viewing supplemental content in accordance with the principles of the present invention.

### DETAILED DESCRIPTION OF THE INVENTION

The present invention pertains to methods and apparatus for permitting subscribers to create enhanced television events and upload them for later viewing by themselves and/or other subscribers to the cable television system.

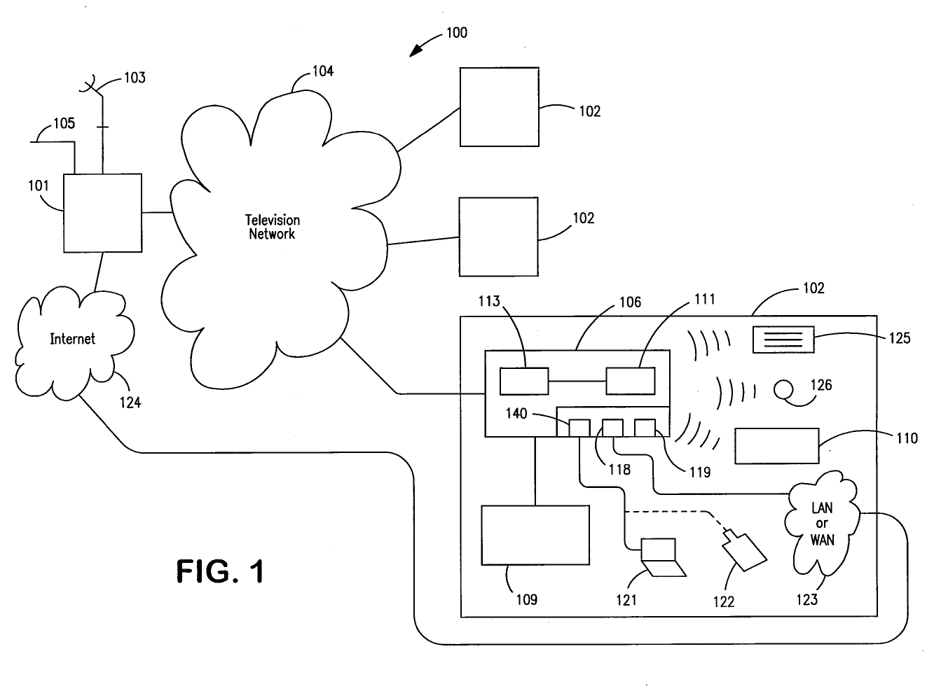

FIG. 1 is a block diagram illustrating a set of components found in a cable television system 100 in which the present invention can be implemented. Cable network system 100 includes a headend 101 that receives content that is to be transmitted or distributed (via broadcast, multicast, unicast, switched digital, video-on-demand (VOD) or any other technique) to the subscriber locations 102 of the cable network system. The headend 101 receives the content to be broadcast from one or more sources, for example, such as a satellite 103 or a landline 105. The data is modulated at the headend 101 for distribution over the medium of the network 104, e.g., coaxial cable, optical fiber, wireless satellite communication, etc., to the subscriber locations 102 in their individual homes or businesses. One particular exemplary subscriber location 102 is shown in detail in FIG. 1. Typically, each subscriber will have a set top box 106 in communication with the headend 101 through the network 104. The set top box 106 commonly will be connected to provide its output to a monitor 109, such as a television set. Commonly, a handheld remote control unit 110 communicates wirelessly (e.g., infrared) with the set top box 106 to control functions and operations of the set top box.

The set top box 106 is capable of receiving the content signals, permitting the user to select a particular channel for viewing, and demodulating the content on that channel to a form that can be displayed on the subscribers television or other monitor 109. The STB further may control access to various channels and other content, such as on demand, pay-per-view programs, premium channels, etc., based on permissions granted to each individual subscriber based on their subscription plan, parental controls, and other criteria.

The set top box 106 can not only receive data from the headend 101 through the network 104, but also transmit data upstream to the headend 101. For instance, set top boxes commonly transmit data upstream for purposes of ordering on demand, pay-per-view content or for providing enhanced television.

The set top box 106 includes a processor 113 for running software to provide various functions. It further includes a memory storage device, such as a hard disk drive 111, for recording television programs and/or other content. Set top boxes with this recording capability are commonly referred to as digital video recorder (DVR) set top boxes (STBs) or DVR-STBs. They provide the user the ability to search through upcoming television programming and selectively designate certain programs of the user's choosing to be recorded. The DVR-STB will then automatically tune into those programs when they are broadcast and record them on to the hard disk 111. DVR-STBs also commonly record whatever show is being watched by the viewer so that the viewer can automatically rewind a program that is being watched in real time. When the program ends, the recording is automatically discarded unless the viewer had expressly requested that it be recorded (either while it was being watched or previously). The set top box 106 is programmed to provide various graphical user interfaces (GUls), such as in the form of menus, permitting the user to interact with the set top box 106 and/or the headend 101 (typically using the remote control unit 110).

The set top box 106 preferably further includes one or more input terminals for accepting digital data from external sources in addition to the network 104. This may include, for instance, one or more of a USB terminal 140 for connecting to a personal computer 121 or a USB memory device 122, a computer network cable terminal 118 for connecting to a LAN or WAN 123 (preferably with connectivity to the Internet 124), a telephone jack 119 for connecting to the Internet via a dial-up or DSL modem and/or a wireless modem. Alternately or additionally, connectivity to the Internet 124 may be provided through the television network 104 itself via the headend 101.

The set top box 106 may be configured with Internet browser software and software for permitting users to interface with the Internet browser software, such as through a keyboard 125 and/or mouse 126.

In accordance with the principles of the invention, the set top box 106 and the headend 101 are configured to permit a subscriber to upload supplemental content at the set top box 106 and transmit it to the headend 101 for use in enhanced television. In this manner, normal television viewers can create and upload supplemental content to their own set top boxes 106 and, if desired, to other subscribers through the television network 104, which supplemental content can be associated with a specific television program and timestamp in that program for later use by themselves and/or other subscribers.

The configuration of the set top box 106 for purposes of the invention would likely comprise providing the set top boxes 106 with software and/or hardware for performing the functionality described hereinbelow for uploading supplemental content and creating enhanced television events. The configuration of the headend 101 would likely comprise a combination of hardware, software, and human resources for performing the functionality of the headend described herein. The software and/or hardware may comprise any one or more of a microprocessor, a processor, combinational logic, a state machine, analog circuitry, digital circuitry, an Application Specific Integrated Circuit (ASIC), a Programmable Logic Array (PLA), and software.

The set top boxes 106 should be configured to offer the following functionality. First, in order to upload supplemental content to the set top box 106, the set top box should have connectivity to external data sources, such as the subscriber's personal computer 121, a USB memory device 122, and/or the Internet 124, as previously discussed in connection with FIG. 1. It also should include functionality for the subscriber to interface with the set top box, such as the aforementioned remote control unit 111, keyboard 125, and/or mouse 126. Further, the set top box 106 should have software for providing functionality for uploading content to the set top box, selecting a television program as well as a particular time stamp within the program, and associating the uploaded content with the particular program and time stamp to create an enhanced television event, as well as appropriate user interfaces, such as graphical user interfaces (GUls), and means for interacting therewith. In one embodiment of the invention, the software at the set top box also provides interfaces and functionality for permitting the subscriber to specify whether the supplemental content is to be made available (1) locally (only at subscribers set top box), and (2) to a particular group of subscribers (either selected by the subscriber or selected by the cable system operator), or (3) to all subscribers.

Turning now to the headend 101, in embodiments of the invention in which subscribers are permitted to create enhanced television events only to be available locally in their own set top box, no modifications would necessarily be implemented in the headend 101. However, if the events may be distributed to other subscribers, then, the headend should be configured to, at least, upload the events from subscribers' set top boxes (including the supplemental content and associated information disclosing the program and time-stamp), recognize them as enhanced television events, and add them to its database of enhanced television events.

Furthermore, in an embodiment that permits the subscriber that created the event to specify the particular subscribers to which the enhanced television event may be made available, the headend also should be configured to accept and recognize such data. The headend also should be configured, in such an embodiment, to read the subscriber data and assure that such enhanced television events can be transmitted only to the selected subscribers. The television network system operator most likely will further wish to screen the supplemental content to ensure that no undesirable content, such as lewd, offensive, slanderous, unauthorized, or pirated content, is distributed to its subscribers.

Finally, the headend 101 should be capable of delivering enhanced television events to subscribers, which includes (1) delivery of enhanced television event notification (e.g., an icon to be displayed in the corner of the monitor) to indicate when an enhanced television event is available, (2) reception of a subscriber's election to view the event, and (3) transmission of the event to the subscriber. These functions, both in the headend and in the set top box, essentially comprise the typical functionality provided by already-existing enhanced television enabled systems.

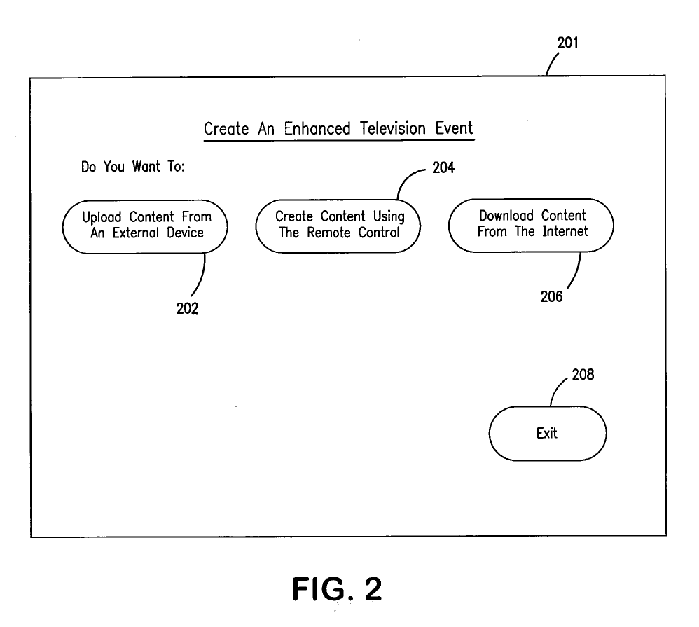

An example of a practical operation of the invention will now be described in connection with one exemplary scenario in which a subscriber wishes to create supplemental content and make it available to a selected group of friends. In this exemplary scenario, the subscriber watches a television program and, at some point during the program, decides that he has something of interest that he would like to share with at least a select group of friends (that he knows are subscribers of the same or a related television service provider). For instance, let us assume that the subscriber is watching a professional football game and recognizes a player who formerly played football for his college alma mater. The subscriber may pause and/or rewind the game using his DVR-STB to the point where he first saw the particular player. Next, he would press a button on the remote control 111 to activate the Create an Enhanced Television Event feature. In response, the software and/or hardware in the set top box is configured to display on the monitor a menu such as menu 201 illustrated in FIG. 2. This menu provides the subscriber with three options in the form of “buttons” on the GUI. Upon selecting a first button 202, the subscriber may upload content from an external device. Upon selecting a second button 204, the subscriber may create supplemental content directly using the remote control and/or set top box. And upon selecting a third button 206, the subscriber may download content from the Internet that will comprise at least a portion of the supplemental content. By selecting a fourth button 208, the subscriber can exit the enhanced television event creator feature. The user would then interface with the STB such as by operating ARROW buttons on the remote control to scroll to the desired selection and then pressing an OK or SELECT button.

The GUI illustrated in FIG. 2 is purely exemplary for purposes of illustration. The form of the menu or even whether the user interface is provided as a menu driven interface is an implementation detail.

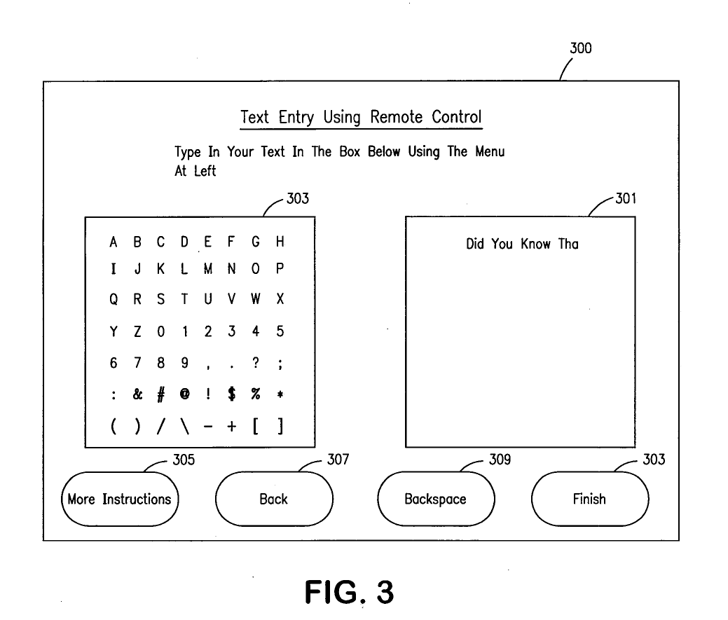

In any event, in this case, the subscriber chooses second button 204 to create content via the set top box. Particularly he wishes to type in text that will comprise the supplemental content. Upon selecting the second button 204, the subscriber is presented with another GUI 300 as shown, for example, in FIG. 3. Menu 300 is an exemplary menu for text entry using the buttons on the remote control unit 111. It includes a character menu window 303 in which the user navigates to characters and selects them for appearing in the text box 301. It also includes a button 305 for calling up another GUI with instruction for entering text, a BACK button 307 that permits the user to go back to the previous GUI (e.g., FIG. 2), a Backspace button 309 for deleting characters in the text box 301, and a Finish button 303 for exiting this GUI and moving on to the next step when the user has finished entering text. Using keyboard 125, mouse 126, and/or the remote-control unit 111, for instance, the user may type in text in text entry box 301 such as “Joe Schmoe, player number 23 for the Podunk Puritans, played for the ZSU Gazelles from 1998-2002, where he held the record for most yards gained by a freshman. If you would like to see his stats while at LSU, visit www.LSU.edu/sports/football/playerprofiles/joe.schmoe.” When the subscriber has finished typing in the text, he can then designate the text for uploading, such as by selecting the FINISH button 303 in GUI 300.

The set top box will then create an enhanced television event by storing the content in the set top box memory along with the identification of the program, a timestamp corresponding to the point where the subscriber paused the program to create the content, and data designating it as an enhanced television event. The manner and form in which the event may be stored are virtually limitless. Merely as an example, the event can be stored as an entry in a database including various fields, such as a unique ID, the supplemental content, a program ID, a timestamp, and a type of entry (i.e., it is an enhanced television event). Alternately or additionally, the set top box 106 may insert meta data in the data stream of the actual television program indicating that an enhanced television event is available and its unique ID. The event can be stored at the local set top box in any other reasonable form, including any of the ways television network operators presently store enhanced television events at the headend or in a recorded program in a DVR-STB.

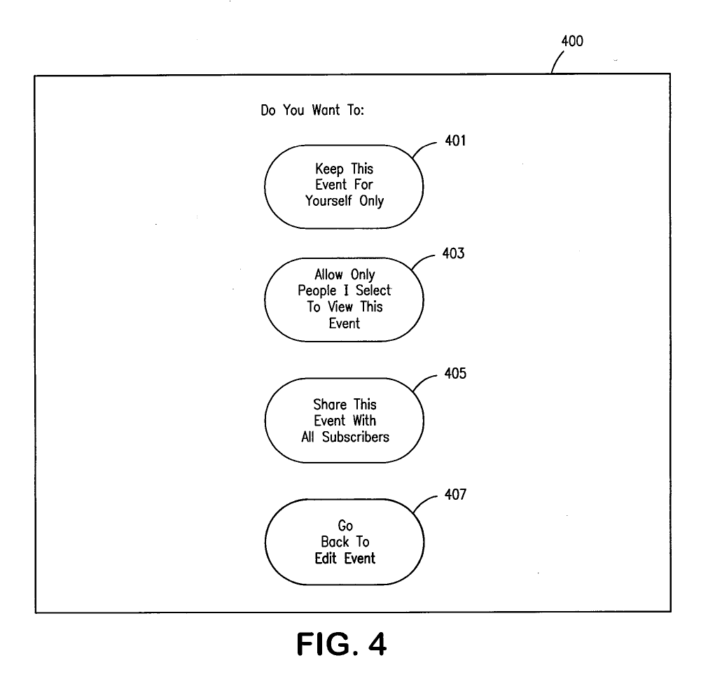

After selecting the FINISH button 303 in GUI 300, another graphical user interface 400 such as illustrated in FIG. 4 might then present the subscriber with buttons to select one of the following options: (1) storing the event only locally on that set top box (button 401), (2) uploading the event to the headend for distribution to a selected group of other subscribers (button 403), or (3) offering the event to all subscribers of the television network system (button 405). The subscriber also is provided a button 407 for going back to edit the event. If the subscriber selects the button 401, in one simple embodiment, the set top box does nothing more after storing the enhanced television event locally on the set top as just described.

Hence, the next time the subscriber watches this program from storage on his DVR, an enhanced television icon will be displayed at the selected point of time in the program and, if the user presses the appropriate button to view enhanced content, he is presented with the enhanced television event, which can be performed in the same manner as a conventional enhanced television event.

If, on the other hand, the subscriber had chosen to share the enhanced television event with a select group of other subscribers (button 403), one or more graphical user interfaces would be displayed on a television monitor permitting the subscriber to enter the identities of the other subscribers with which he desires to share the enhanced television event. This may be done in any reasonable way, such as, for instance, entering the e-mail addresses, telephone numbers, or the names of the subscribers in a text entry box. The television system operator would be able to identify the subscribers (and the unique identification codes of their set top boxes) because the television system operator has previously collected such information from its subscribers. The user may simply access a pre-existing group list of subscribers that he has previously created (e.g., like a mailing list). Even further, the television system operator may actually offer to its subscribers predetermined group lists of subscribers with common thematic interests for use in distributing subscriber-created enhanced television events. For instance, the television system operator may permit subscribers to sign up for various group lists, such as Philadelphia Eagles fanatics, Seinfeld fanatics, Monty Python fanatics, and Red Dwarf fanatics and create such group lists from the list of subscribers that sign up for such lists. In any event, in this example, the set top box, in addition to storing the event on the local set top box as described above, would also transmit the event upstream to the headend 101.

Finally, if the subscriber designated the event for sharing with all of the subscribers (button 402), the set top box may upload the event data to the headend without providing the subscriber an opportunity to enter a list of subscribers.

At the headend, the television system operator may screen the content as previously mentioned to determine whether the supplemental content is appropriate for an enhanced television event to be shared with other subscriber. If the operator determines that the event is appropriate for sharing, it creates and stores the event just as it would any enhanced television event obtained from more conventional sources, such as an enhanced television content provider or the producer of the television program. For instance, the enhanced television event dataset (e.g., the supplemental content, the unique ID, the program ID, and the timestamp) may be stored in an appropriate database. Also, an enhanced television event flag may be inserted into the metadata of the corresponding television program at the corresponding point in time within the program so that when the program is broadcast to subscribers, the enhanced television icon will be displayed at that time.

In embodiments in which the creator has the option of choosing subscribers with whom to share the event, the dataset also may include a data field indicating the subscribers to which it may be made available. This can be done by providing a field in the dataset for identifying the subscribers to which the enhanced television event will be made available. If the creator of the event chooses to make it available without restriction, this field could be populated with a code indicating so.

The process of screening the supplemental content can take any number of forms. For instance, scanning software is now available that can search text and audio/video content for foul language and/or images, nudity, and other inappropriate content. At this time, such software probably is not sufficiently robust to catch all inappropriate content. Accordingly, human intervention will still likely be desirable (i.e., a human would view the content) not only to assure that it does not contain nudity, profanity, pirated content, etc., but also to assure that it is of sufficient quality to be offered as an enhanced television event.

Since most programs are broadcast many times, the newly created enhanced television event can be viewed by many subscribers in the future. Nevertheless, there are several ways that the television system operator can make the event even more readily available. For instance, if the creator of the event specifies a list of subscribers to which the event should be made available, the television system operator might send those subscribers an e-mail through the Internet or a message through the subscriber messaging service of the television network system itself notifying them that they have been invited to view the program and that it contains an enhanced television event. It may even disclose who created the event. Alternately or additionally, the television system operator may automatically download the program to the DVR-STBs of the specified subscribers (or, alternately, program those DVRs to record the program the next time it is broadcast). The message/email alternately or additionally may inform the recipients when the program will be broadcast again so that the subscriber can easily program his or her own DVR-STB to record the program and/or can simply watch the program when it is broadcast.

In accordance with another feature of the invention, the headend can check whether a designated subscriber has already recorded the program, and if so, include in the message an email indication that the subscriber has already recorded the program and asking the subscriber if he or she wishes to download the enhanced television event to be associated with the program previously recorded (and then do so, if requested).

Even further, upon the successful uploading and storing of an enhanced television event at the headend associated with a program that is still being transmitted, the television system operator may cause the enhanced television icon to be displayed while the program is being transmitted (but, obviously, at a time later in the program than the timestamp with which the event is associated). In such a case, responsive to a subscriber activating the enhanced television button, the subscriber can be presented with a GUI indicating that an enhanced television event has just been created in connection with the program being viewed and asking if the subscriber wishes to rewind to the point in the program with which that event is associated. Alternately or additionally, the subscriber may be given the option of viewing the event at the present point in the program without rewinding, even though it is later than the corresponding timestamp.

Alternately or additionally, the television system operator may provide a mechanism by which subscribers can directly access a listing of enhanced television events that are available to them and the programs to which they correspond. Those programs could then be made available for downloading immediately, similarly to an on demand or pay-per-view feature. Alternately, the television system operator could permit the subscriber to select an option that causes the subscriber's set top box to record a selected program the next time it is broadcast. In one embodiment of the invention, the system would allow the subscriber to add the program to his/her DVR recording schedule simply by selecting the program directly from the listing of programs.

While the invention has been described in connection with an embodiment in which the server-side functionality of the invention is provided at a headend, it will be readily understood by those skilled in the related arts that this is merely exemplary and that this functionality can be provided at any server-side node of the system. For instance, in a cable television system operated by a Multi-System Operator (MSO), the subscriber may be connected to a headend, which, in turn, may be connected to a local operations center, which, in turn, may be connected to a regional operation center, which, in turn, may be connected to a national operations center. The server-side functionality described herein could be embodied in any of these nodes. The term headend as used in this specification is intended to encompass any node of the network that is upstream of the subscribers' set top boxes, with the data simply passing through the intervening nodes, including the headend node.

In the above-described exemplary embodiment, the subscriber created a simple text enhanced television event using the set top box. However, in other scenarios, the subscriber can create the content independently of the STB and upload it to the set top box through an appropriate connection. The subscriber can create multimedia events containing any one or more of video, still pictures, text, audio, Internet content, etc. For example, the set top box may be connected directly to a personal computer for uploading content. Alternately or additionally, the set top box may have a USB port for connection to a USB memory device. Also, in connection with Internet-enabled set top boxes having connectivity to the Internet and browser software, the user may be permitted to upload supplemental content directly from the Internet into the set top box. The user can then add additional supplemental content, such as by typing text directly into the set top box or downloading it from another source to create an event comprising a combination of the Internet content and the other supplemental content.

In one embodiment, the STB may be configured with multi-media creation software that will permit a subscriber to create complex multi-media content directly on the STB.

In scenarios in which the supplemental content include a URL, a subscriber with an Internet-enabled set top box having connectivity to the Internet, any URL text can be made an active hyperlink, so that the subscribers viewing the event can hyperlink directly to the URL.

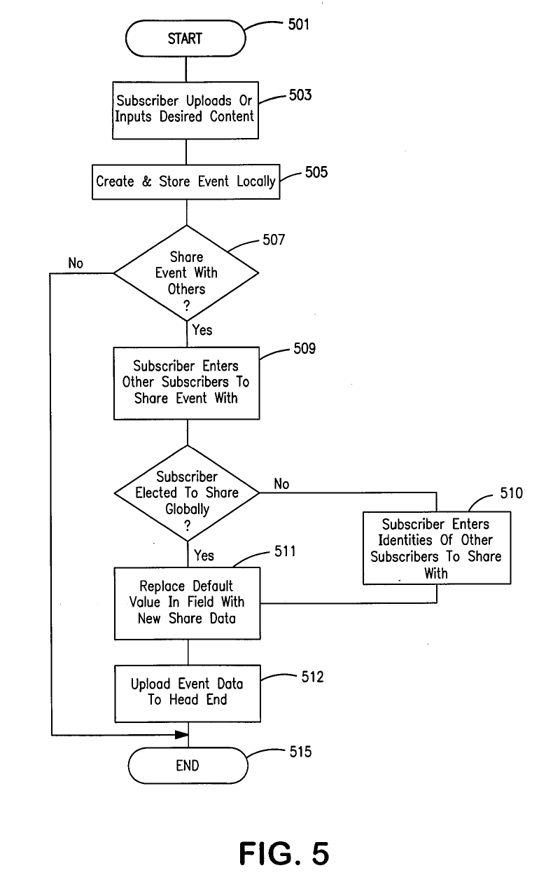

FIG. 5 is a flow diagram illustrating process flow at the subscriber's set top box in accordance with one particular exemplary embodiment of the present invention. The process is invoked in step 501 when the subscriber depresses the button on the set top box 106 or remote-control unit 111 for activating the feature for creating an enhanced television event. Next, in step 503, the subscriber enters the content of the enhanced television event into the set top box. As previously described, there are many ways that this can be accomplished, including receiving it from the Internet, creating it directly in the set top box, receiving it from an external memory device, and combinations thereof. When the supplemental content is uploaded or entered, the set top box creates an enhanced television event dataset, including at least the content, the program ID, and a timestamp, as previously mentioned. In a preferred embodiment, the dataset includes a field that will indicate the set of subscriber with which the event may be shared (containing only a default value at this time). Flow proceeds to step 505 where the event is stored in memory at the local set top box. Next, the subscriber is presented with several options for sharing the enhanced television event. In this exemplary embodiment, the subscriber can create a strictly local event, share the event with a specified set of subscribers, or share the event globally with all subscribers.

Thus, in step 507, the user indicates whether he/she wishes to share the event.

If the subscriber chooses not to share the enhanced television event, nothing else needs to be done, so flow proceeds to END step 515. If, on the other hand, the subscriber wishes to share the event, flow proceeds to step 509, where the subscriber is asked to enter the subscriber or subscribers with which he wishes to share the event. Next, in step 510, if the subscriber chose to share the event globally with all subscribers, flow proceeds to step 511 in which the election is substituted into the sharing field of the event dataset.

If, on the other hand, the subscriber chooses to share the event only with a selected group of subscribers, flow proceeds first to step 510, in which the subscriber enters the identities of those subscribers. Then, flow proceeds to step 511, in which the dataset is updated with that data. Next, in step 512, the event is uploaded to the headend. The process ends at step 515.

The selection of a subscriber-created enhanced television event for viewing at the set top box can be handled just like any conventionally created enhanced television event. Therefore, a flowchart and further detailed description thereof is not provided.

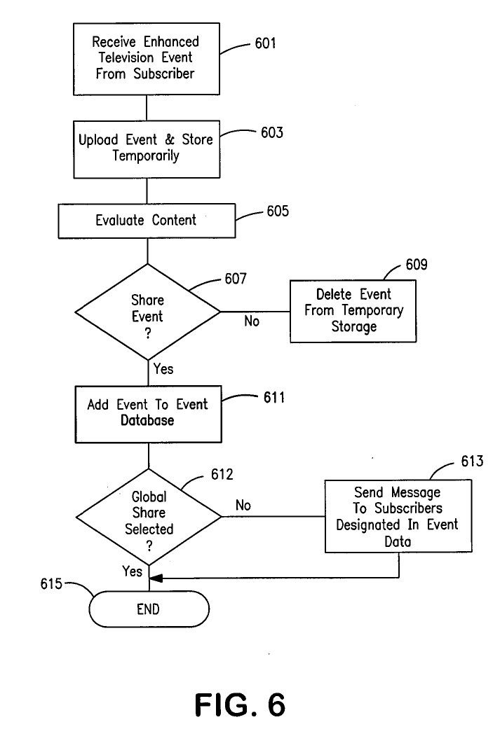

Turning now to the headend, FIG. 6 illustrates processing flow in connection with the reception and storage of enhanced television events uploaded from subscribers. The process is commenced at step 601 when the headend receives an enhanced television event dataset from one of its subscribers (e.g., step 512 in FIG. 5). Upon receipt, in step 603, the dataset is uploaded and stored temporarily for screening. Next, in step 605, the content is evaluated to determine whether the television system operator wishes to permit sharing of the enhanced television event. As previously described, this may include running the content through one or more software algorithms that search for profanity, nudity, pirated content, etc. In addition, most likely, this also will include human intervention wherein a human reviews the content for all the above factors as well as, perhaps, quality. Then, in step 607, a determination is made whether to share the event. If a decision is made not to make the enhanced television event available, then flow proceeds to step 609, in which the content is erased from temporary memory. In an alternative embodiment of the invention, the subscriber also may be sent a message indicating that an enhanced television event was not created.

If, on the other hand, a determination is made in step 607 to share the enhanced television event, flow instead proceeds to step 611, in which the event is written into the appropriate database at the headend. Next, in step 612, the event data is queried to determine whether the event creator designated the event to be globally shared with all subscribers having access to the corresponding program or a subset thereof. As previously noted, if the event is to be shared globally, the event data may include a field indicating as much and flow proceeds to end step 615 since no further processing in connection with the event may be needed. If, on the other hand, the event is to be shared with a selected group of subscribers, then processing instead flows to step 613, in which a message is sent to the selected subscribers to inform them of the existence of the event. Some of the various ways in which this message might be formulated and sent have been discussed herein above and will not be repeated in detail. However, FIG. 6 illustrates one particular embodiment. In this embodiment, in step 613, the headend sends a message via the television network's messaging system to the selected subscribers informing them of the creation of the events and asking them if they want to transmit the corresponding program, including the event. Finally, flow proceeds to end step 615.

The delivery of the subscriber-created enhanced television events has already been described in detail hereinabove and the technical aspects thereof can be largely the same as that used in connection with conventionally-created enhanced television events. Accordingly, no flowchart or further detailed discussion thereof is necessary.

Even further, the television network operator may choose to further share such enhanced television events with other entities, such as other television network operators free of charge or for a fee.

Thus, in accordance with the invention, normal television viewers are able to create enhanced television events in their homes and upload them to their set top boxes or to the television system operator for sharing with other subscribers via their set top boxes. This should greatly increase the volume of enhanced television events available to the public.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

I claim:

1. A method of generating an enhanced television event at a subscriber node in a television network comprising:
selecting a television program via the subscriber node;
selecting a point in the television program using the subscriber node;
generating content comprising the enhanced television event; and
creating an enhanced television event dataset associating the content with the television program and the point in the television program.

2. The method of claim 1 wherein the selecting of a television program comprises playing the television program.

3. The method of claim 2 wherein the playing the television program comprises one of (a) writing the television program into a memory storage device in the subscriber node simultaneously with the playing of the program and (b) reading the television program from the memory storage device, and wherein the selecting of a point in the television program comprises pausing the television program at the point.

4. The method of claim 1 wherein the generating content comprises uploading the content from a memory device external of the subscriber node.

5. The method of claim 1 wherein the generating content comprises generating multi-media content in a subscriber node comprising multi-media authoring tools.

6. The method of claim 1 wherein the generating content comprises downloading content from the Internet using the subscriber node.

7. The method of claim 1 further comprising:
uploading the enhanced television event from the set top box via the television network to a headend of the television network.

8. The method of claim 7 further comprising:
entering at the subscriber node identities of other subscribers of the television network to which the enhanced television event is to be available for viewing;
including the identities in the enhanced television event dataset prior to uploading.

9. The method of claim 7 further comprising:
receiving the enhanced television event from the subscriber node via the television network to a headend of the television network;
evaluating the content of the enhanced television event dataset at the headend and determining whether to make the enhanced television event dataset available to subscribers of the television network;
if a determination is made to not make the enhanced television event dataset available to subscribers, deleting the enhanced television event dataset; and
if a determination is made to make the enhanced television event dataset available to subscribers, making the enhanced television event dataset available to subscribers of the television network via the headend.

10. The method of claim 1 wherein the subscriber node comprises a set top box.

11. A method of obtaining enhanced television events for sharing with subscribers of a television network comprising a headend and a plurality of subscriber nodes:
receiving at a headend of the television network enhanced television event datasets via the television network from subscriber nodes, the enhanced television event datasets each comprising content, a television program identifier, and a time stamp within the program; and
making at least one of the enhanced television event datasets available to subscribers from the headend via the network as an enhanced television event.

12. The method of claim 11 further comprising:
determining whether the content of each enhanced television event dataset is suitable for sharing with subscribers; and
making the content available only if it is determined to be suitable for sharing with subscribers.

13. The method of claim 11 wherein the enhanced television event dataset further comprises a list of subscribers of the television network to which access to the enhanced television event dataset is to be restricted, the method further comprising:
notifying the subscribers in the list of the existence of the enhanced televisions event dataset.

14. The method of claim 11 wherein the enhanced television event dataset further comprises a list of subscribers of the television network to which access to the enhanced television event dataset is to be restricted, the method further comprising:
making the enhanced television event available only to the subscribers of the television network identified in the enhanced television event.

15. The method of claim 11 further comprising:
automatically downloading the program, including the enhanced television event dataset, to the subscriber nodes of the subscribers in the list.

16. The method of claim 11 further comprising:
offering to download the program, including the enhanced television event dataset, to the subscriber nodes of the subscribers in the list; and
if the subscriber accepts the offer, downloading the program, including the enhanced television event dataset, to the subscriber node of the subscriber.

17. The method of claim 11 further comprising including in said messages an option permitting the subscribers to cause the subscribers' nodes to record the television program, including the enhanced television event dataset, a next time it is broadcast via the television network.

18. The method of claim 11 further comprising:
determining at the headend whether a subscriber node connected to the television network already had the television program recorded therein before the enhanced television event dataset was upload to the headend; and
if so, sending a message to the subscriber node indicating that an enhanced television event has been created corresponding to the program and offering to download the enhanced television event dataset to the subscriber node to be associated with the program recording.

19. A computer program product for creating enhanced television event datasets and uploading them to a headend of a television network comprising:
computer executable code for playing a television program;
computer executable code for enabling a user to select a point in the television program;
computer executable code for inputting and storing the content in a memory storage device; and
computer executable code for creating an enhanced television event dataset by associating the content with the television program and the point in the television program.

20. The computer program product of claim 19 further comprising:
computer executable code for uploading the enhanced television event via the television network to a headend of the television network.

21. The computer program product of claim 19 further comprising:
computer executable code for enabling a user to enter identities of other subscribers of the television network to which the enhanced television event is to be available for viewing;
computer executable code for inserting the identities in the enhanced television event dataset prior to uploading.

22. The computer program product of claim 19 further comprising:
computer executable code for authoring multi-media content.

23. A computer program product for obtaining enhanced television events for sharing the enhanced television events with subscribers of a television network comprising a headend and a plurality of subscriber nodes:
computer executable code for downloading enhanced television event datasets from subscriber nodes to a headend, the enhanced television event dataset comprising content, a television program identifier, and a time stamp within the program; and
computer executable code for making the enhanced television event dataset available to subscribers from the headend via the network as an enhanced television event.
a headend that receives content, datasets, distributes content and datasets, et

24. A system for generating an enhanced television event at a subscriber node in a television network and sharing the enhanced television event with others, the system comprising:
a subscriber-side device adapted to permit a user to select a television program, permit the user to select a point in the television program, receive content for an enhanced television event, create an enhanced television event dataset by associating the content with the television program and the point in the television program, and upload the enhanced television event to a server-side node of the television network; and
a server-side device adapted to receive the enhanced television event dataset from the subscriber node via the television network, and make the enhanced television event dataset available to subscribers of the television network.

25. The system of claim 24 wherein the subscriber-side device is further adapted to permit a user to enter identities of other subscribers of the television network to which the enhanced television event is to be available for viewing and to include the identities in the enhanced television event dataset.

26. The system of claim 24 wherein the server-side device is further adapted to evaluate the content of the enhanced television event dataset and determine whether to make the enhanced television event dataset available to subscribers of the television network.

27. The system of claim 24 wherein the subscriber-side device further comprises multi-media authoring tools and is further adapted to generate content using the multi-media authoring tools.
